(19) United States
(12) Patent Application Publication
(10) Pub. No.: US 2008/0148102 A1
(43) Pub. Date: Jun. 19, 2008

(54) METHOD FOR ENHANCING DEBUGGING OF RUNTIME MEMORY ACCESS ERRORS BY USING AN INTEGRATED VISUALIZATION TOOL AND A RUNTIME MEMORY ERROR DETECTION TOOL

(75) Inventors: Gregory Tseytin, Campbell, CA (US); Tanuj Vohra, Campbell, CA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/611,191

(22) Filed: Dec. 15, 2006

(51) Int. Cl. G06F 11/00

(52) U.S. Cl. 714/37; 714/E11.002

(57) ABSTRACT

A method for enhancing debugging of runtime memory access errors by using an integrated heap visualization tool and a runtime memory error detection tool. The method includes displaying a plurality of memory allocations. The method further includes selecting a portion of memory. The method proceeds by analyzing the selected portion of memory. The method further includes executing the integrated heap visualization tool and the runtime memory error detection tool. A user is allowed to set a breakpoint in the user code where the memory was at least one of (i) last allocated, and (ii) freed.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates in general to a runtime memory error detection tool, and more particularly to a runtime memory error detection tool integrated with a heap memory visualization tool used for enhancing debugging of runtime memory access errors.

2. Description of Background

Run time memory misuse errors, such as uninitialized memory reads, reads and writes beyond array bounds, memory leaks, and free memory access are extremely hard to find. Especially if the programming language has no provisions to prevent it. An example is that in C/C++, it is perfectly legal for a programmer to declare arrays of a particular size, and then access elements beyond the size of that array. An example of a memory error in C/C++ is shown below. Most compilers do not detect this error, and the language allows it without any qualms. As such, it is perfectly legal for a programmer to declare arrays of a particular size, and then access elements beyond the size of that array.

For example, consider the following code.

```
    int*a; // declare a pointer to an integer
    a=(int*)malloc(20 * sizeof(int)); // allocate space for 20 intergers as
an array on the heap
    a[21] =5; // access the 22^{nd} element of the array of integers.
```

Here, the access a [21] is to a piece of memory that was not allocated by the program, and might either be unallocated memory on the heap, or memory that was allocated by another piece of the program. This is illegal and potentially dangerous but not detected by most modern C/C++ compilers.

There are tools that allow for the detection of such errors. The known solutions suffer from several drawbacks. For instance, one tool does not attempt heap visualization, it utilizes application programming interfaces (APIs) to query heap memory addresses to better understand what's in those locations. Such APIs instruct a user about where a block was allocated or freed, but there is now way to step through allocation or frees.

Thus, there is a need to use a heap visualization tool for a runtime analysis product and extend the visualization capabilities of the heap visualization tool, while also better integrating the heap visualization tool with the debugger.

### SUMMARY OF THE INVENTION

The shortcomings of the prior art are overcome and additional advantages are provided through the provision of a method for enhancing debugging of runtime memory access errors by using an integrated heap visualization tool and a runtime memory error detection tool. The method includes displaying a plurality of memory allocations. The method further includes selecting a portion of memory. The method proceeds by analyzing the selected portion of memory. The method further includes executing the integrated heap visualization tool and the runtime memory error detection tool. A user is allowed to set a breakpoint in the user code where the memory was at least one of (i) last allocated, and (ii) freed.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for enhancing debugging of runtime memory access errors by using an integrated heap visualization tool and a runtime memory error detection tool.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for enhancing debugging of runtime memory access errors by using an integrated heap visualization tool and a runtime memory error detection tool.

The detailed description explains an exemplary embodiment of the invention, together with advantages and features, by way of example with reference to the drawing.

### DETAILED DESCRIPTION OF THE INVENTION

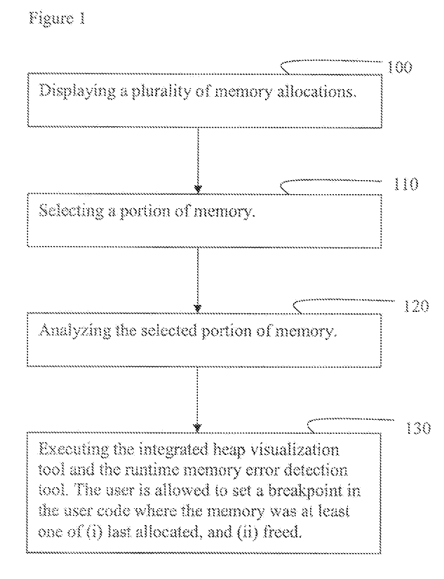

Referring to FIG. 1, a method for enhancing debugging of runtime memory access errors by using an integrated heap visualization tool and a runtime memory detection tool is shown.

At step 100, a plurality of memory allocations is displayed. At step 110, a portion of memory is selected. At step 120, the selected portion of memory is analyzed. Then, at step 130, the integrated heap visualization tool and the memory error detection tool is used. The user is allowed to set a breakpoint in the user code where the memory was either allocated or freed. The heap visualization tool allows the user to visualize memory usage and memory errors to facilitate debugging.

A set of all heap items are identified from a set of heap items allocated from a given function or from a given point in the function. The results may be used to determine if block allocations for such items are advisable to avoid memory fragmentation.

Another reason is that functions necessary to analyze the accessibility of heap items cannot provide a single item (i.e., when the user wants to know where are pointers to this item preventing it from being garbage-collected). This is the reason why sets of heap items must be handled accordingly.

For a given function, the user may obtain a list of not only the current active set of heap items, but also those that were allocated by the function but freed since the time of that allocation. This list may be used to allow the user to determine if there is excessive and unnecessary allocation and deallocation within a function that can be avoided.

The user may create a subset of heap items from the previously defined set. The subset may be defined by size, allocation, and amount of time between allocation and being freed. This provides a better understanding of heap usage. An example would be to determine if memory allocations from a certain function are excessive.

The user may build a set of heap items that are accessible from at least one item in the current set. Furthermore, the user may build a set of heap items from which at least one item of the current set may be accessed. These functions are necessary to ensure that there are no spurious paths of access to otherwise unnecessary heap items.

Afterwards, the visualization of the point in the control flow to show where the item was allocated is invoked. Alternatively, where the item became inaccessible and eligible for garbage collection, visualization of the control flow may be invoked at this juncture. Visualization is useful when listing the names of functions in the call chain because the call chain alone is not very intuitive.

While the preferred embodiments to this invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for enhancing debugging of runtime memory access errors by using an integrated heap visualization tool and a runtime memory error detection tool, comprising:
displaying a plurality of memory allocations;
selecting a portion of memory,
analyzing the selected portion of memory; and
executing the integrated heap visualization tool and the runtime memory error detection tool; and
wherein a user is allowed to set a breakpoint in the user code where the memory was at least one of (i) last allocated, and (ii) freed.

2. A method as set forth in claim 1, further comprising:
identifying a set of all heap items from at least one of (i) all heap items allocated from a given function, and (ii) all heap items allocated from a given point in the function, and using the identified results to determine if block allocations are necessary to avoid memory fragmentation.

3. A method as set forth in claim 2, wherein for a given function the user may obtain a list of currently active set of heap items and a list of heap items that were allocated by the function but freed since the time of the allocation.

4. A method as set forth in claim 3, wherein the user may create a subset of heap items from the previously defined set, such subset being defined by at least one of, (i) size, (ii) allocation, and (iii) amount of time between allocation and being freed.

5. A method as set forth in claim 4, further comprising:
building a set of heap items that are accessible from at least one item in the current set.

6. A method as set forth in claim 5, further comprising:
building a set of heap items from which at least one item of the current set may be accessed.

7. A method as set forth in claim 6, further comprising:
invoking visualization of control flow to show where the item was allocated and where the item was freed.
